(19) United States
(12) Patent Application Publication
(10) Pub. No.: US 2016/0062293 A1
(43) Pub. Date: Mar. 3, 2016

(54) Device Management Apparatus, Recording Medium and Device Management Method That Enables To Supply Replenishing or Replacement Efficiently

(71) Applicant: Kyocera Document Solutions Inc., Osaka (JP)

(72) Inventors: Takeshi Nakamura, Osaka (JP); Daisuke Yoshida, Osaka (JP); Takashi Nomura, Osaka (JP); Yuichi Obayashi, Osaka (JP); Chika Tsuji, Osaka (JP); Jumpei Takagi, Osaka (JP); Katsuhiro Minoru, Osaka (JP)

(21) Appl. No.: 14/839,403

(22) Filed: Aug. 28, 2015

(30) Foreign Application Priority Data
Aug. 28, 2014 (JP) 2014-173554

(51) Int. Cl. G03G 15/00; G03G 15/08

(52) U.S. Cl. CPC G03G 15/553

(57) ABSTRACT

A device management apparatus includes an information acquisition circuit, a supply target setting circuit, a supply time prediction circuit, and a simultaneous supply target setting circuit. The supply target setting circuit sets the expendables in a supply requiring time as a supply target of the replenishing or replacement. The supply time prediction circuit predicts a supply requiring time for an expendable other than the supply target of the plurality of expendables based on the acquired information. The simultaneous supply target setting circuit sets the expendable the predicted supply requiring time of which is within a range of a specific identical time period to the supply requiring time for the supply target as a simultaneous supply target. The simultaneous supply target is replenishing or replacement to be supplied to the identical supply destination together with the replenishing or replacement to be supplied to the supply target.

### INCORPORATION BY REFERENCE

This application is based upon, and claims the benefit of priority from, corresponding Japanese Patent Application No. 2014-173554 filed in the Japan Patent Office on Aug. 28, 2014, the entire contents of which are incorporated herein by reference.

### BACKGROUND

Unless otherwise indicated herein, the description in this section is not prior art to the claims in this application and is not admitted to be prior art by inclusion in this section.

When using an image forming apparatus such as a printer as an electronic device, what is called a remote maintenance contract is sometimes made between a user and a management company.

The remote maintenance connects a management server of the management company and an image forming apparatus of the user by a network such as Internet. The remote maintenance monitors whether or not a remaining amount of toner, which is an expendable of the image forming apparatus, is a low toner remaining amount decreased to equal to or less than a threshold value by the management server.

Then, when the toner remaining amount of the image forming apparatus becomes the low toner remaining amount, the management server determines that it is a time for a replenishing or replacement toner (hereinafter referred to as “supply requiring time”), and, the management company for example supplies the replenishing or replacement toner to the user by shipping or similar way.

Accordingly, the remote maintenance is highly convenient for the user because a labor of the user to monitor the toner remaining amount actively and a labor of the user to order the replenishing or replacement toner are saved.

However, the remote maintenance can cause the image forming apparatus to notify the detected low toner remaining amount to the management server and cause the management server to determine the supply requiring time when the low toner remaining amount is detected in the image forming apparatus.

In view of this, the management server cannot determine the toner of the image forming apparatus to be in the supply requiring time unless the toner remaining amount of the image forming apparatus actually becomes the low toner remaining amount.

As a result, in a case of an image forming apparatus including a plurality of toners such as a color printer, a toner to be the low toner remaining amount in the identical time period such as a few days after may exist other than a toner actually with the low toner remaining amount. Then, there is a problem that the toners are determined to be in the supply requiring time separately.

In this case, the replenishing or replacement toners should be shipped to the user several times in a short period of time and it is complicated for both such as the management company and the user.

Such problem may occur as well on the management of a plurality of toners in a plurality of image forming apparatuses connected to an internal network such as a local area network (LAN) of the user.

The remote maintenance is used to electronic devices in every field because of the spread of Internet. Then, a similar problem to the case of the image forming apparatus may occur on an electronic device in the other field.

### SUMMARY

A device management apparatus according to one aspect of the disclosure supports supply of expendables to one or more electronic devices each having a plurality of expendables. The one or more electronic devices are located in an identical supply destination for supplying replenishing or replacement of the expendables. The device management apparatus includes an information acquisition circuit, a supply target setting circuit, a supply time prediction circuit, and a simultaneous supply target setting circuit. The information acquisition circuit acquires information from the one or more electronic devices including the plurality of expendables. The supply target setting circuit sets the expendables in a supply requiring time as a supply target of the replenishing or replacement when one or more expendables of the plurality of expendables are determined to be in the supply requiring time for the replenishing or replacement based on the acquired information. The supply time prediction circuit predicts a supply requiring time for an expendable other than the supply target of the plurality of expendables based on the acquired information. The simultaneous supply target setting circuit sets the expendable the predicted supply requiring time of which is within a range of a specific identical time period to the supply requiring time for the supply target as a simultaneous supply target, the simultaneous supply target being replenishing or replacement to be supplied to the identical supply destination together with the replenishing or replacement to be supplied to the supply target.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 conceptually illustrates a device management system including a device management apparatus according to Embodiment 1 of the disclosure.

FIG. 2 illustrates a configuration of the device management system according to Embodiment 1.

FIG. 3 illustrates steps of a device management processing by the device management system according to Embodiment 1.

FIG. 4 illustrates a configuration of a device management system according to Embodiment 2 of the disclosure.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The disclosure is according to a device management apparatus, a device management system, and a device management method that predicts expendables coming to a supply requiring time in identical time period to a supply target that has come to a supply requiring time among a plurality of expendables of one or more electronic devices in the identical supply destination. The device management apparatus, a device management system, and a device management method of the disclosure realize an object that makes enable to supply replenishing or replacement of expendables of an electronic device coming to a supply requiring time in identical time period to a user in the identical supply destination in one time even if the supply requiring time is not identical.

As the plurality of expendables of one or more electronic devices, for example, there are one or more expendables included in each of a plurality of electronic devices connected to an internal network in the identical supply destination other than a plurality of expendables included in a single electronic device, and similar expendables.

When the electronic device is an image forming apparatus, the expendables can be assumed to be such as a toner used for image formation.

When the expendable is a toner, a corresponding toner may be a supply target based on low toner information acquired from the image forming apparatus. The low toner information is information that indicates a toner remaining amount to be equal to or less than a threshold value.

For a toner other than the supply target, the supply requiring time is predicted based on an image formation information, which is acquired from the image forming apparatus, relating to image formation.

In this case, an image formation trend of the image forming apparatus can be acquired from the image formation information. Then, the supply requiring time of a toner other than the supply target may be predicted based on the acquired image formation trend.

### Outline of Device Management System

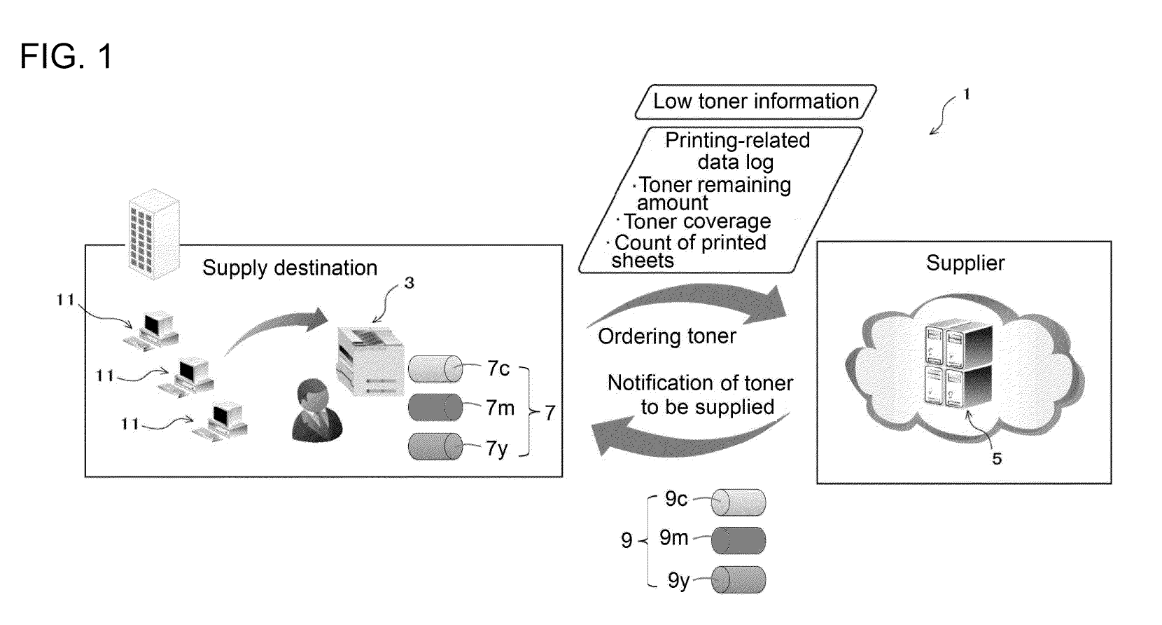

FIG. 1 conceptually illustrates a device management system with a device management apparatus according to Embodiment 1 of the disclosure. As illustrated in FIG. 1, a device management system 1 is configured to connect an image forming apparatus 3, which is an electronic device of a user side, to a management server 5, which is a device management apparatus of a management company side, via an external network such as the Internet. In FIG. 1, while only the image forming apparatus 3 of the single user is indicated for convenience, usually, image forming apparatuses of a plurality of users are present on the device management system 1.

The image forming apparatus 3 is such as a color printer and a color multi-functional peripheral including toners 7 of a plurality of colors as expendables. In the embodiment, the toners 7 of the plurality of colors are cyan toner 7c, magenta toner 7m, and yellow toner 7y. As the expendables, such as a drum may be included other than the toner 7. In this case, the image forming apparatus 3 may be such as a single color printer with a single toner. The image forming apparatus 3 is located in a supply destination of the toner 7 such as an office of the user.

The image forming apparatus 3 of the embodiment is connected to a client terminal 11, which is an information processing device such as a personal computer, via an internal network such as a LAN. The image forming apparatus 3 performs a print job as an image formation consuming the toner 7 on a paper sheet based on a job for printing transmitted from the client terminal 11 for example. The print job may be performed based on a job of copying, facsimile and similar job.

The management server 5 is a cloud server and located in such as an office of a management company as a supplier, which is different from the supply destination of the toner 7. The supplier may be different from the management company. The management server 5 collects and accumulates information from the image forming apparatus 3 to ensure remote maintenance to the image forming apparatus 3.

Specifically, the management server 5 monitors the toner remaining amount of the image forming apparatus 3. When the toner remaining amount becomes the low toner remaining amount equal to or less than the threshold value, the management server 5 causes the corresponding replenishing or replacement toner 9 (the replenishing or replacement) to be shipped (supplied) from the supplier such as the management company to the supply destination as the user. In the following description, the replenishing or replacement toner 9 will be described as a replacement toner 9.

In the remote maintenance of the embodiment, when one or more remaining amount of toners 7 among a plurality of the toners 7 (for example, the cyan toner 7c) of the image forming apparatus 3 become the low toner remaining amount, corresponding replacement cyan toner 9c is shipped to the supply destination with replacement magenta toner 9m for the other magenta toner 7m, which becomes the low toner remaining amount in identical time period, in one time.

This ensures that, in the image forming apparatus 3, when the low toner remaining amount of the one or more toners 7 (for example, the cyan toner 7c) is detected, the low toner information indicating the detected low toner remaining amount will be informed to the management server 5. At this time, the image forming apparatus 3 transmits a printing-related data log to the management server 5 with the low toner information. The printing-related data log is information accumulating such as the toner remaining amount, a toner coverage, and a count of printed sheets (a count of used paper sheet in image formation).

The management server 5 controls an accumulated data log further accumulating the printing-related data log from the image forming apparatus 3. Then, the management server 5 predicts a toner 7 (for example, the magenta toner 7m) that becomes the low toner remaining amount in identical time period to the toner 7 (for example, the cyan toner 7c) with the low toner remaining amount based on the accumulated data log as image formation information relating to printing (image formation) acquired from the image forming apparatus 3. Based on the prediction result, the management company or similar supplier can ship the replacement toner 9 (the cyan toner 9c and the magenta toner 9m) to the plurality of toners 7 (the cyan toner 7c and the magenta toner 7m), which become the supply requiring time in identical time period, to the user as the supply destination in one time.

Corresponding to the remote maintenance contract, the shipping of the replacement toner 9 is made automatically, made after the order from the user, or made similar way. This embodiment indicates the case where the replacement toner 9 is shipped after the order from the user. Accordingly, the management server 5 notifies the image forming apparatus 3 of the user of the replacement toners 9 to be supplied in one time and receives the order made on the image forming apparatus 3.

The following describes the device management system 1 in detail with specific configuration of the image forming apparatus 3 and the management server 5.

### Detail of Device Management System

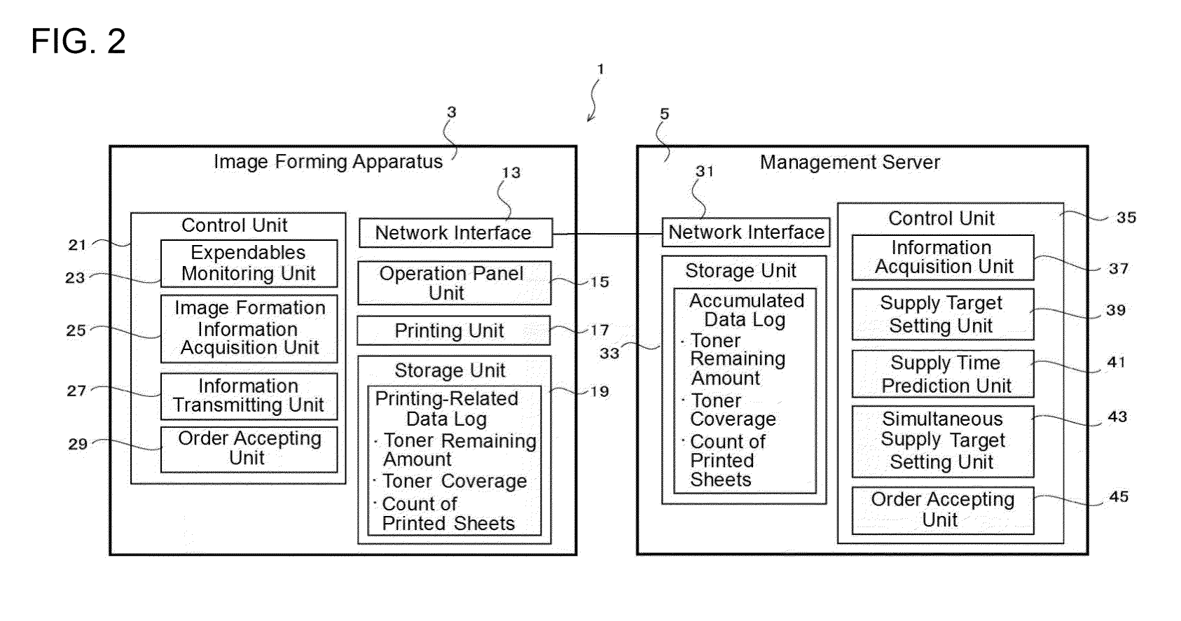

FIG. 2 illustrates a configuration of the device management system 1 in FIG. 1. FIG. 2 indicates the image forming apparatus 3 and the management server 5, and omits the client terminal 11. The image forming apparatus 3 of the embodiment includes a network interface 13, an operation panel unit 15, a printing unit 17, a storage unit 19, a control unit 21, and similar unit.

As illustrated in FIGS. 1 and 2, the network interface 13 is a circuit such as a network interface card that connects the image forming apparatus 3 to the client terminal 11 via the internal network to ensure transmitting and receiving data. The network interface 13 connects the image forming apparatus 3 to the management server 5 via the external network to ensure transmitting and receiving data.

The operation panel unit 15 is a circuit that includes a touch-panel liquid crystal display screen or a similar screen. The operation panel unit 15 ensures to input operations to the image forming apparatus 3 and to display the operation state.

The printing unit 17 includes a circuit and a mechanism that consumes the toner 7 to form an image on a paper sheet based on image data such as the input job.

The storage unit 19 is a storage device such as a read only memory (ROM) storing various control applications and data necessary to control, a random access memory (RAM) as a work area, a hard disk drive (HDD) as an auxiliary storage device, and similar device.

The control unit 21 is a processor such as a central processing unit (CPU) that executes programs to cause the programs to control each unit of the image forming apparatus 3 and to perform operations. The execution of the program in the storage unit 19 makes the control unit 21 of the embodiment function as an expendables monitoring unit 23, an image formation information acquisition unit 25, an information transmitting unit 27, and an order accepting unit 29.

The expendables monitoring unit 23 is a circuit that ensures the expendables monitoring function. The expendables monitoring unit 23 monitors whether or not the remaining amount of the toner 7, which is the expendable of the image forming apparatus 3, is the low toner remaining amount equal to or less than the threshold value (consumption amount is equal to or more than the threshold value). In monitoring whether or not the toner remaining amount is the low toner remaining amount, the low toner remaining amount is detected, for example, based on the accumulated count of printed sheets of the image forming apparatus 3. The low toner remaining amount can be detected by such as a sensor.

The image formation information acquisition unit 25 is a circuit that ensures the image formation information acquiring function. The image formation information acquisition unit 25 acquires printing-related data (variable) that varies based on the print job performed in the image forming apparatus 3 and affects the remaining amount of the toner 7.

Specifically, every time that the print job is performed, the image formation information acquisition unit 25 acquires the count of printed sheets, the toner coverage, the toner remaining amount and similar information as the printing-related data. The acquired printing-related data is stored in the storage unit 19 and accumulated as the printing-related data log.

The information transmitting unit 27 is a circuit that ensures information transmitting function. The information transmitting unit 27 transmits and informs the management server 5 of the low toner information indicating the low toner remaining amount when the expendables monitoring unit 23 confirms the toner 7 with the low toner remaining amount. The low toner information may be information indicating the supply requiring time of the toner 7 with the low toner remaining amount.

The information transmitting unit 27 is a circuit that transmits the printing-related data log in the storage unit 19 to the management server 5 corresponding to confirming the toner 7 with the low toner remaining amount. In the embodiment, while the printing-related data log is transmitted with the low toner information, the printing-related data log can be transmitted at a timing different from the low toner information. The printing-related data may be transmitted to the management server 5 every time that the print job is performed. In this case, it is not necessary to transmit the printing-related data log from the image forming apparatus 3 to the management server 5.

The order accepting unit 29 is a circuit that ensures order accepting function. The order accepting unit 29 receives a notification about the replacement toner 9, which is to be supplied from the management server 5 in one time, and accepts the order of the replacement toner 9 notified on the operation panel unit 15. The order accepting unit 29 transmits the accepted order to the management server 5. The order accepting unit 29 may be functioned by such as the client terminal 11 controlled by the user.

The management server 5 is an information processing device. The management server 5 includes a network interface 31, a storage unit 33, and a control unit 35.

The network interface 31, the storage unit 33, and the control unit 35 are configured as well as respective units of the image forming apparatus 3. Namely, the network interface 31 connects the management server 5 to the image forming apparatus 3 via the external network to ensure transmitting and receiving data. The storage unit 33 is a storage device such as a ROM, a RAM, and a HDD. The control unit 35 is a processor such as a CPU.

The execution of the program in the storage unit 33 by the control unit 35 makes the management server 5 of the embodiment functions as an information acquisition unit 37, a supply target setting unit 39, a supply time prediction unit 41, a simultaneous supply target setting unit 43, and an order accepting unit 45.

The information acquisition unit 37 is a circuit that ensures the information acquisition function to acquire information from the image forming apparatus 3. In the embodiment, the information acquisition unit 37 receives to acquire the low toner information and the printing-related data log transmitted from the image forming apparatus 3.

The received low toner information and printing-related data log are stored in the storage unit 33. The stored printing-related data log is accumulated as an accumulated data log.

The supply target setting unit 39 is a circuit that ensures the supply target setting function. The supply target setting unit 39 sets the toner 7 (for example, the cyan toner 7c) in the supply requiring time as the supply target for the replacement toner 9 (for example, the cyan toner 9c) when one or more toners 7 (for example, the cyan toner 7c) of the plurality of the toners 7 of the image forming apparatus 3 are in the supply requiring time for the replacement toner 9 based on the low toner information acquired by the information acquisition unit 37.

The supply time prediction unit 41 is a circuit that ensures the supply time predicting function. The supply time prediction unit 41 predicts the supply requiring time to the toner 7 (the magenta toner 7m and the yellow toner 7y) other than the supply target of the plurality of the toners 7 (for example, the cyan toner 7c) of the image forming apparatus 3 based on the accumulated data log in the storage unit 33. In predicting the supply requiring time, the printing-related data log received from the image forming apparatus 3 can be used instead of the accumulated data log.

The supply time prediction unit 41 of the embodiment predicts the supply requiring time with considering the latest toner remaining amount included in the accumulated data log and a print job trend of the user (image formation trend) acquired from the accumulated data log.

The print job trend includes an underlying trend and a correction trend to correct the underlying trend. The underlying trend is an amount of toner consumption per unit time, for example, such as the amount of toner consumption a day. The underlying trend ensures the supply requiring time to be calculated based on the latest toner remaining amount in the accumulated data log. The correction trend is a trend specific to the user, for example, a trend that the print job is much performed at the beginning of a month, at the end of a month, at the beginning of a year, at the end of a year, and similar time, and a time such as the company event is held. The correction trend ensures a correction coefficient in calculating the supply requiring time to be set.

The amount of toner consumption per unit time in the underlying trend can be calculated with various methods. For example, based on the accumulated data log, calculate an average amount of toner consumption with an average toner coverage to one paper sheet. Then, multiplying the calculated average amount of toner consumption on an average count of paper sheet use a day makes the amount of toner consumption a day.

The simultaneous supply target setting unit 43 is a circuit that ensures the simultaneous supply target setting function. The simultaneous supply target setting unit 43 sets the toner 7 (for example, the magenta toner 7m), of which the predicted supply requiring time is within a range of a specific identical time period of the supply requiring time for the supply target (for example, the cyan toner 7c), as a simultaneous supply target, for which the replacement magenta toner 9m is supplied to the supply destination with the replacement cyan toner 9c supplied to the supply target (for example, the cyan toner 7c).

The range of the identical time period can be set, for example, with considering a time period until the toner 7 as the supply target is consumed perfectly. In this case, as described above at the explanation of the supply time prediction unit 41, the simultaneous supply target setting unit 43 calculate an estimated shipping date that makes the replacement toner 9 provided before the toner 7 as the supply target is consumed perfectly with considering the print job trend. Then, the simultaneous supply target setting unit 43 simply sets a time period from the time when the supply requiring time came to the estimated shipping date as the range of the identical time period. In the embodiment, the range of the identical time period is set 3 days.

The order accepting unit 45 is a circuit that ensures the order accepting function. The order accepting unit 45 notifies the image forming apparatus 3 of the replacement toner 9 to be supplied to the supply destination in one time and accepts an order of the notified replacement toner 9 from the image forming apparatus 3. When the order accepting unit 45 accepts the order of the replacement toner 9, the order accepting unit 45 notifies the supplier of the acceptance.

### Device Management Processing

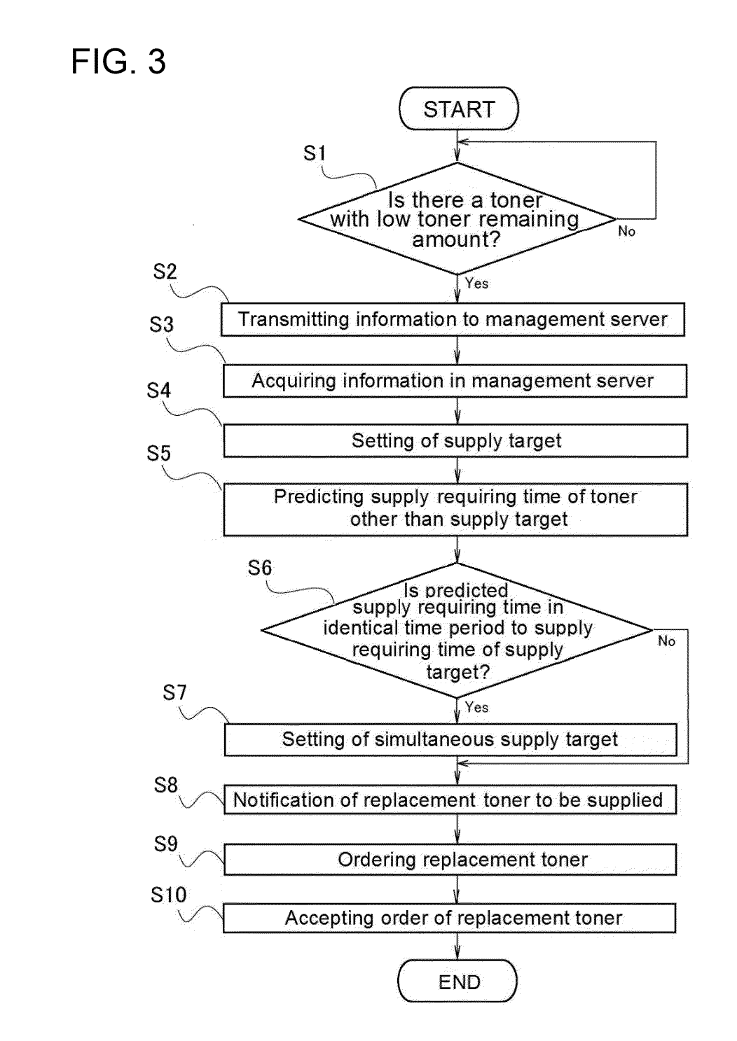

The following describes a procedure of a device management process by the device management system 1 as a device management method. FIG. 3 illustrates steps of the device management processing by the device management system 1 according to Embodiment 1 of the disclosure. In the device management processing, first, a process of Step S1 “Is there a toner with the low toner remaining amount?” is performed every time that a print job in the image forming apparatus 3 is completed. Namely, the expendables monitoring unit 23 of the image forming apparatus 3 determines whether or not the toner 7 with the low toner remaining amount exists corresponding to completing the print job based on the accumulated count of printed sheets of the printing-related data log accumulated in the storage unit 19 and the toner coverage per unit count of sheets.

When the toner 7 with the low toner remaining amount exists, the process proceeds to Step S2 (YES). Whenever the toner 7 with the low toner remaining amount does not exist, the process of Step S1 is repeated every time that the print job is completed.

Step S2 performs a process of “transmitting information to the management server.” Namely, the information transmitting unit 27 of the image forming apparatus 3 transmits the low toner information to the management server 5 and notifies of the toner 7 with the low toner remaining amount. At this time, the information transmitting unit 27 transmits the printing-related data log with the low toner information to the management server 5.

When Step S2 is thus completed, the process proceeds to Step S3.

Step S3 performs a process of “acquiring information in the management server.” Namely, the information acquisition unit 37 of the management server 5 receives and acquires the low toner information and the printing-related data log transmitted from the image forming apparatus 3 and stores the acquired low toner information and the printing-related data log in the storage unit 33.

When Step S3 is thus completed, the process proceeds to Step S4.

Step S4 performs a process of “setting of the supply target.” Namely, the supply target setting unit 39 of the management server 5 sets the toner 7 in the supply requiring time with the low toner remaining amount as the supply target for the replacement toner 9 based on the low toner information transmitted from the image forming apparatus 3.

When Step S4 is thus completed, the process proceeds to Step S5.

Step S5 performs a process of “predicting the supply requiring time of the toner other than the supply target. “Namely, the supply time prediction unit 41 of the management server 5 predicts the supply requiring time of the toner 7 other than the toner 7 as the supply target based on the accumulated data log. As described above, considering the print job trend of the user ensures the prediction of the supply requiring time with high accuracy corresponding to the print job trend of the user.

When Step S5 is thus completed, the process proceeds to Step S6.

Step S6 performs a process of “Is the predicted supply requiring time in identical time period to the supply requiring time of the supply target?” Namely, the simultaneous supply target setting unit 43 of the management server 5 determines whether or not the predicted supply requiring time is within a range of the identical time period to the supply requiring time of the toner 7 as the supply target. In the embodiment, the range of the identical time period is set 3 days, then, the simultaneous supply target setting unit 43 determines whether or not the predicted supply requiring time is within 3 days from the supply requiring time of the toner 7 as the supply target.

When the predicted supply requiring time is within the range of the identical time period to the supply requiring time of the supply target, the process proceeds to Step S7 (YES). When the predicted supply requiring time is out of range of the identical time period to the supply requiring time of the supply target, the process proceeds to Step S8 (NO).

Step S7 performs a process of “setting of the simultaneous supply target.” Namely, the simultaneous supply target setting unit 43 of the management server 5 sets the toner 7, of which the predicted supply requiring time is in the identical time period to the supply requiring time of the supply target, as the simultaneous supply target. This ensures the replacement toners 9 for the toners 7 of the supply target and the simultaneous supply target to be supplied to the supply destination in one time.

When Step S7 is thus completed, the process proceeds to Step S8.

Step S8 performs a process of “notification of the replacement toner to be supplied.” Namely, the order accepting unit 45 of the management server 5 notifies the image forming apparatus 3 of the replacement toners 9 to be supplied to the supply destination in one time. When the process proceeds from Step S6, only the replacement toner 9 for the toner 7 as the supply target is notified the image forming apparatus 3.

When Step S8 is thus completed, the process proceeds to Step S9.

Step S9 performs a process of “ordering the replacement toner.” Namely, the order accepting unit 29 of the image forming apparatus 3 accepts the order of the notified replacement toner 9 by the user on the operation panel unit 15 of the image forming apparatus 3.

The order is accepted as follows: a person who has an authority of the user side (authorized person) logs in the image forming apparatus 3, and inputs the order of the replacement toner 9 notified from the management server 5 on the operation panel unit 15.

In this case, indicating the notification from the management server 5 on the operation panel unit 15 of the image forming apparatus 3 all the time promotes the order by transmitting the notification to the authorized person when a person other than the authorized person confirms the notification. However, only when the authorized person logs in the image forming apparatus 3, the notification from the management server 5 may be indicated on the operation panel unit 15. When a specific time period passed from receiving the notification, the image forming apparatus 3 may promote the order by sending an e-mail to the client terminal 11 of the authorized person.

When Step S9 is thus completed, the process proceeds to Step S10.

Step S10 performs a process of “accepting the order of the replacement toner.” Namely, the order accepting unit 45 of the management server 5 accepts the order of the replacement toner 9 from the image forming apparatus 3 and notifies the supplier of the replacement toner 9.

The supplier can ship the replacement toners 9 for the toners 7 of the supply target and the simultaneous supply target in one time to the supply destination corresponding to the notification from the management server 5. Through Step S6, S8, and S9, when the replacement toner is ordered only for the toner 7 as the supply target, Step S10 accepts the order of the replacement toner 9 for the toner 7 as the supply target. Then, the supplier ships the replacement toner 9 for the toner 7 as the supply target to the supply destination.

### Effect of Embodiment 1

The management server 5 as a device management apparatus of the embodiment includes the information acquisition unit 37, the supply target setting unit 39, the supply time prediction unit 41, and the simultaneous supply target setting unit 43. The information acquisition unit 37 acquires information from the image forming apparatus 3 including a plurality of toners 7 located at the identical supply destination to supply the replacement toner 9 for the toner 7 from the supplier. The supply target setting unit 39 sets the toner 7 in the supply requiring time as the supply target for the replacement toner 9 when one or more toners 7 of the plurality of toners 7 are determined to be in the supply requiring time for the replacement toner 9 based on the acquired information. The supply time prediction unit 41 predicts the supply requiring time to the toner 7 other than the supply target of the plurality of toners 7 based on the acquired information. The simultaneous supply target setting unit 43 sets the toner 7 (for example, the magenta toner 7m), of which the predicted supply requiring time is within a range of a specific identical time period of the supply requiring time for the supply target (for example, the cyan toner 7c), as a simultaneous supply target, for which the replacement magenta toner 9m is supplied to the identical supply destination with the replacement cyan toner 9c supplied to the supply target (for example, the cyan toner 7c).

Then, the management server 5 can set even the toner 7 that has not been in the supply requiring time as the simultaneous supply target for which the replacement toner 9 is to be supplied to the identical supply destination with the toner 7 as the supply target in the supply requiring time when the predicted supply requiring time is within a range of the identical time period to the supply requiring time of the toner 7 that has already been in the supply requiring time.

Accordingly, the management server 5 can cause the replacement toners 9 for the toners 7 of the supply target and the simultaneous supply target to be supplied in one time from the supplier to the identical supply destination even if the supply requiring time is not identical.

As a result, the embodiment can reduce the burden of shipping for the management company and the labor of receiving for the user.

In the management server 5 of the embodiment, the supply target setting unit 39 sets the appropriate toner 7 as the supply target based on the low toner information indicating the toner remaining amount acquired from the image forming apparatus 3 equal to or less than the threshold value. The supply time prediction unit 41 predicts the supply requiring time of the toner 7 other than the supply target based on the printing-related accumulated data log acquired from the image forming apparatus 3.

Therefore, the embodiment surely ensures to set the toner 7, of which the supply requiring time has come, as the supply target based on the low toner information, and the embodiment surely ensures to predict the supply requiring time of the toner 7 other than the supply target based on the accumulated data log.

Especially, in the embodiment, the supply time prediction unit 41 acquires the print job trend of the image forming apparatus 3 from the accumulated data log, and predicts the supply requiring time of the toner 7 other than the supply target based on the acquired print job trend. Therefore, the embodiment ensures to predict the supply requiring time with high accuracy corresponding to the print job trend of the user.

The device management program of the embodiment ensures the functions of each unit of the management server 5 to cause the replacement toner 9 for the toner 7 as the supply target and the simultaneous supply target to be supplied from the supplier to the identical supply destination in one time even if the supply requiring time is not identical.

The device management method of the embodiment includes the information acquisition unit 37 as an information acquisition method, which acquires information from the image forming apparatus 3 including a plurality of toners 7 located at the identical supply destination to supply the replacement toner 9 for the toner 7 from the supplier, the supply target setting unit 39 as a supply target setting method, which sets the toner 7 in the supply requiring time as the supply target for the replacement toner 9 when one or more toners 7 of the plurality of toners 7 are determined to be in the supply requiring time for the replacement toner 9 based on the acquired information, the supply time prediction unit 41 as a supply time prediction method, which predicts the supply requiring time to the toner 7 other than the supply target of the plurality of toners 7 based on the acquired information, and the simultaneous supply target setting unit 43 as a simultaneous supply target setting method, which sets the toner 7 of which the predicted supply requiring time is within a range of a specific identical time period to the supply requiring time for the supply target as a simultaneous supply target for which the replacement toner 9 is supplied to the identical supply destination with the replacement toner 9 supplied to the supply target.

Therefore, the device management method of the embodiment ensures to cause the replacement toner 9 for the toner 7 as the supply target and the simultaneous supply target to be supplied from the supplier to the identical supply destination in one time even if the supply requiring time is not identical.

In the device management method of the embodiment, while the information acquisition unit 37, the supply target setting unit 39, the supply time prediction unit 41, and the simultaneous supply target setting unit 43 of the management server 5 as a single device achieve the information acquisition method, the supply target setting method, the supply time prediction method, and the simultaneous supply target setting method, a part of or all the methods may be achieved by different devices.

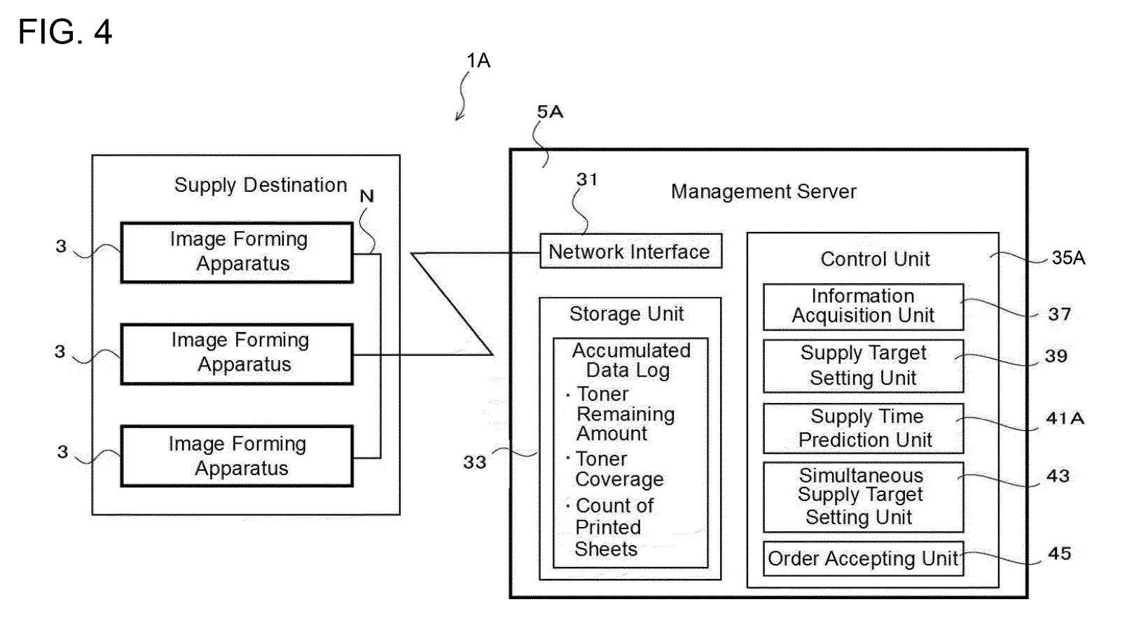

FIG. 4 illustrates a configuration of a device management system according to Embodiment 2 of the disclosure. Embodiment 2 has a basic configuration in common with Embodiment 1. Therefore, like reference numerals or the identical reference numerals with A are given to corresponding configurations, and the repeated description will be omitted correspondingly.

As illustrated in FIG. 4, in a device management system 1A of the embodiment, a plurality of image forming apparatuses 3 are connected via an internal network N of the user. Each image forming apparatus 3 is the identical to the image forming apparatus 3 of Embodiment 1.

When one of the plurality of the image forming apparatuses 3 detects the toner 7 of each image forming apparatus with a low toner remaining amount, the image forming apparatus 3 transmits a printing-related data log to a management server 5A with a low toner information. When the other image forming apparatuses 3 in the internal network N receive a notification from the image forming apparatus 3 that detected the low toner remaining amount, it is only necessary to transmit the printing-related data log to the management server 5A.

Alternatively, each image forming apparatus 3 may transmit the printing-related data to the management server 5A regularly or every time that a print job terminates to cause the management server 5A to store the accumulated data log for each image forming apparatus 3.

Then, when the toner 7 of one or more image forming apparatus 3 become in the low toner remaining amount, a supply time prediction unit 41A of the management server 5A predicts a supply requiring time of the other toners 7 of all the image forming apparatuses 3 in the internal network N based on the accumulated data log.

This ensures the embodiment to supply the replacement toners 9 in one time similar to Embodiment 1 over the toners 7 of the plurality of the image forming apparatus 3 in the internal network N.

The embodiment can acquire the print job trend of the user more accurately based on the accumulated data log acquired from the plurality of the image forming apparatuses 3. Then, the embodiment achieves the prediction of the supply requiring time with higher accuracy.

Besides, the operations and effects similar to Embodiment 1 can also be achieved in the embodiment.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A device management apparatus for supporting supply of expendables to one or more electronic devices each having a plurality of expendables, the one or more electronic devices being located in an identical supply destination for supplying replenishing or replacement of the expendables, the device management apparatus comprising:
an information acquisition circuit that acquires information from the one or more electronic devices including the plurality of expendables;
a supply target setting circuit that sets the expendables in a supply requiring time as a supply target of the replenishing or replacement when one or more expendables of the plurality of expendables are determined to be in the supply requiring time for the replenishing or replacement based on the acquired information;
a supply time prediction circuit that predicts a supply requiring time for an expendable other than the supply target of the plurality of expendables based on the acquired information; and
a simultaneous supply target setting circuit that sets the expendable the predicted supply requiring time of which is within a range of a specific identical time period to the supply requiring time for the supply target as a simultaneous supply target, the simultaneous supply target being replenishing or replacement to be supplied to the identical supply destination together with the replenishing or replacement to be supplied to the supply target.

2. The device management apparatus according to claim 1, wherein the information acquisition circuit acquires information from single electronic device including the plurality of expendables.

3. The device management apparatus according to claim 1, wherein the information acquisition circuit is connected to an internal network in the identical supply destination to acquire information from the plurality of electronic devices each including one or more expendables.

4. The device management apparatus according to claim 1, wherein:
the electronic device is an image forming apparatus;
the expendables are toners used for image formation;
the supply target setting circuit sets a toner as the supply target corresponding to low toner information, the low toner information being based on a toner remaining amount, acquired from the image forming apparatus, equal to or less than a threshold value; and
the supply time prediction circuit predicts the supply requiring time for a toner other than the supply target based on image formation information related to image formation, the image formation information being acquired from the image forming apparatus.

5. The device management apparatus according to claim 4, wherein the supply time prediction circuit acquires an image formation trend of the image forming apparatus from the image formation information, and the supply time prediction circuit predicts the supply requiring time of the toner other than the supply target based on the acquired image formation trend

6. A non-transitory computer-readable recording medium storing a device management program to control a device management apparatus for supporting supply of expendables to one or more electronic devices each having a plurality of expendables, the one or more electronic devices being located in an identical supply destination for supplying replenishing or replacement of the expendables, the device management program causes a computer to function as:
an information acquisition circuit that acquires information from the one or more electronic devices including the plurality of expendables;
a supply target setting circuit that sets the expendables in a supply requiring time as a supply target of the replenishing or replacement when one or more expendables of the plurality of expendables are determined to be in the supply requiring time for the replenishing or replacement based on the acquired information;
a supply time prediction circuit that predicts a supply requiring time for an expendable other than the supply target of the plurality of expendables based on the acquired information; and
a simultaneous supply target setting circuit that sets the expendable the predicted supply requiring time of which is within a range of a specific identical time period to the supply requiring time for the supply target as a simultaneous supply target, the simultaneous supply target being replenishing or replacement to be supplied to the identical supply destination together with the replenishing or replacement to be supplied to the supply target.

7. A device management method for supporting supply of expendables to one or more electronic devices each having a plurality of expendables, the one or more electronic devices being located in an identical supply destination for supplying replenishing or replacement of the expendables, the device management method comprising:
an information acquisition circuit's acquiring information from the one or more electronic devices including the plurality of expendables;
a supply target setting circuit's setting the expendables in a supply requiring time as a supply target of the replenishing or replacement when one or more expendables of the plurality of expendables are determined to be in the supply requiring time for the replenishing or replacement based on the acquired information;
a supply time prediction circuit's predicting a supply requiring time for an expendable other than the supply target of the plurality of expendables based on the acquired information; and
a simultaneous supply target setting circuit's setting the expendable the predicted supply requiring time of which is within a range of a specific identical time period to the supply requiring time for the supply target as a simultaneous supply target, the simultaneous supply target being replenishing or replacement to be supplied to the identical supply destination together with the replenishing or replacement to be supplied to the supply target.
